(19) United States
(12) Patent Application Publication
(10) Pub. No.: US 2014/0098030 A1
(43) Pub. Date: Apr. 10, 2014

(54) TOUCH MODULE

(71) Applicant: Yao-Tsung TANG, Kaohsiung City (TW)

(72) Inventor: Yao-Tsung TANG, Kaohsiung City (TW)

(21) Appl. No.: 13/647,717

(22) Filed: Oct. 9, 2012

(51) Int. Cl. G06F 3/041

(52) U.S. Cl. 345/173

(57) ABSTRACT

A touch module includes a body including a substrate defining an active area and touch points in the active area, and force sensors arranged around the substrate and electrically connected to a control unit for measuring the variation of force at each touch point upon touch by an object, generating and transmitting a corresponding electronic signal to the control unit to determine the two-dimensional coordinates of the touch point and movement of applied force subject to the rule that the amount of applied force is indirectly proportional to the distance between the touched point and each force sensor or the rule of torque balance relationship. The touch module is switchable between different operation modes subject to the amount of applied force, and can correct the touch point deviation value subject to different application purposes and status of use, enhancing sensing accuracy and stability.

### BACKGROUND OF THE INVENTION

1. Field of the Invention

The present invention relates to touch module technology and more particularly, to a touch module, which comprises a body having an active area with touch points defined in a substrate thereof, and force sensors arranged around the substrate for measuring the variation of force at each touch point for enabling a control unit to determine the two-dimensional coordinates of the touch point been touched by an external object.

2. Description of the Related Art

With the development of electronic technology and rapid spread of network communication applications, people's lives, learning, work and entertainment have been changed for better quality. Nowadays, computer has become a requisite tool for individuals and enterprises for doing many things, including word processing, account processing, internet messaging, or e-mail handling. However, a desk computer must be used with a keyboard and a mouse for data input, limiting its application.

In view of the above-mentioned reasons, touchscreen that can translate the motion and position of a user's fingers to a relative position on screen is thus created. A touchscreen is known commonly used in a smart phone, tablet computer, PDA or any other electronic device to detect the presence and location of a touch within the display area. Users can interact with the electronic device having a touchscreen to control the movement of the cursor, to click a menu on the screen, and to drag an object on the screen without going through the keyboard. A touchscreen has the advantages of handwriting input and operating convenience. There are a variety of touchscreen technologies that have different methods of sensing touch, including resistive, capacitive, projected capacitance, surface acoustic wave, infrared, optical imaging, force-sensing touch technology, and etc. Generally, these touchscreen technologies are selectively applied subject to size requirements capacitive type and resistive type touchscreen technologies are commonly for small size applications, such as smart phone and PDA. Newly developed technology applications commonly adopt a projected capacitance type touchscreen. Infrared, optical imaging and force-sensing touch technologies are commonly used in interactive multimedia tours guide system, query system, ATM, game console and other large size electronic devices.

Further, a resistive touchscreen comprises two thin, transparent conductive layers, separated by a thin space. When a fingertip or stylus tip presses on the top conductive layer, the top and bottom conductive layers come into electrical contact, and a voltage applied across the conductive layers results in a flow of current proportional to the location of the contact. By detecting the current change, the touch location is determined. However, these two thin, transparent electrically-resistive layers are prepared from a flexible material. Therefore, these two thin, transparent conductive layers are easily scratched and have the drawbacks of short life and poor transmittance. During application, a touchscreen of this type must be used with a backlight, increasing power consumption. A capacitive touchscreen relies on the change in capacitance due to the approach of the human body to detect the location where the user touches. This type of touchscreen is able to detect a touch even when the user presses lightly on the touchscreen. Thus, it eliminates the abrasion of the touchscreen. Therefore, a capacitive touchscreen is superior to a resistive touchscreen in light transmission, durability and response speed. Further, a capacitive touchscreen has multi-touch capability. However, a capacitive touchscreen generally cannot be used with a mechanical stylus or a gloved hand. Further, electrostatic coupling effects arise due to the touch of a finger, and thus the problem of deviation is more serious. Moreover, a small and medium-size capacitive touchscreen has poor performance. Also, surrounding electrical inductance and magnetic inductance may interfere with normal functioning of a capacitive touchscreen. Improvement in this regard is necessary.

### SUMMARY OF THE INVENTION

The present invention has been accomplished under the circumstances in view. It is therefore the main object of the present invention to provide a touch module, which comprises a body comprising a substrate defining an active area and a plurality of touch points in said active area, a plurality of force sensors arranged around the substrate for measuring the variation of force at each touch point when an external object touches the active area of the substrate and converting the variation of force at each touch point into a corresponding electronic signal, and a control unit electrically connected with the force sensors for receiving the electronic signal provided by each force sensor and converting the electronic signal into a corresponding digital signal for determination of the two-dimensional coordinates of the touch point touched and the moving direction of the applied force. Further, the touch module is switchable between different operation modes subject to the amount of applied force, and can correct the touch point deviation value subject to different application purposes and status of use, enhancing sensing accuracy and stability.

It is another object of the present invention to provide a touch module, which determines the two-dimensional coordinates of the touch point touched subject to the rule that the amount of applied force is inversely proportional to the distance between the touched point and each force sensor or the rule of torque balance relationship. Further, the substrate is selectively prepared from tempered glass, rigid sheet materials, or any other suitable light-transmissive thin sheet material or opaque thin sheet material, eliminating the drawbacks of low light transmissivity and low rigidity of conventional resistive type touchscreens, and the drawbacks of nonconductor inapplicability, positional deviation, high error rate, high risk of touchpad or touchscreen failure of conventional induction type, capacitive type and electromagnetic type touchscreens.

It is still another object of the present invention to provide a touch module, which has the touch points arranged in a grid pattern in the active area, wherein the control unit is adapted to establish a database subject to the proportional relationship obtained by using an object to touch each coordinate point in the active area of the substrate and comparing the amount and variation of the applied force measured by each force sensor so that when an external object touches one point in the sensitive area of said substrate, the control unit determines the two-dimensional coordinates of the touched point by matching the proportional relationship obtained from the values measured by the force sensors with the database.

The substrate can be configured to provide a rectangular, circular or polygonal shape, and selected from the group of resistive type, capacitive type, electromagnetic type, surface acoustic wave type and optical type (infrared) touchpads and touchscreens. Further, the force sensors can be selected from the group of piezoelectric force sensors, capacitive force sensors, potentiometric force sensors, inductive force sensors, magneto-resistive strain gauges and pneumatic power sensors.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic top plain view of a touch module in accordance with the present invention.

FIG. 2 is a schematic drawing illustrating a first operation mode of the touch module in accordance with the present invention (I).

FIG. 3 is a schematic drawing illustrating the first operation mode of the touch module in accordance with the present invention (II).

FIG. 4 is a schematic drawing illustrating the first operation mode of the touch module in accordance with the present invention (III).

FIG. 5 is a schematic top plain view of an alternate form of the touch module in accordance with the present invention.

FIG. 6 is a schematic top plain view of another alternate form of the touch module in accordance with the present invention.

FIG. 7 is a schematic drawing illustrating a second operation mode of the touch module in accordance with the present invention.

### DETAILED DESCRIPTION OF THE PREFERRED EMBODIMENT

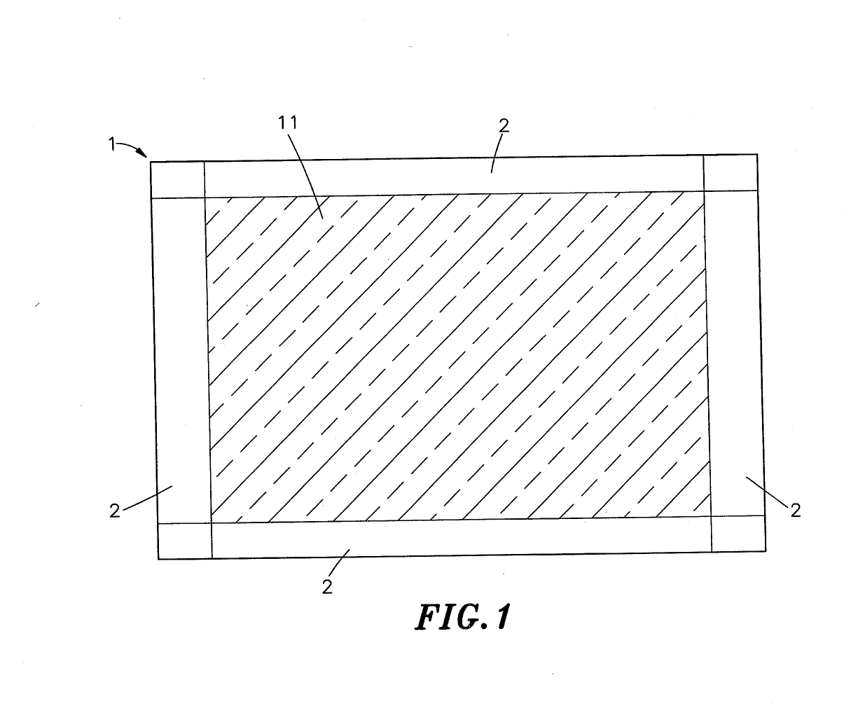

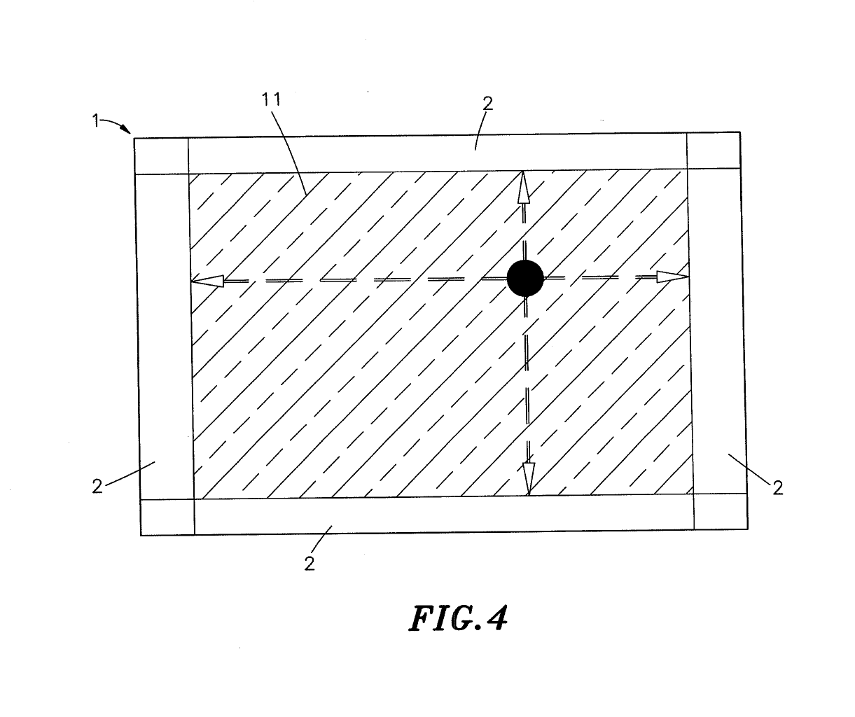

Referring to FIGS. 1-4, a touch module in accordance with the present invention is shown. The touch module comprises a body 1, and a plurality of force sensors 2. The body 1 comprises a substrate 11 that can be a planar tempered glass, rigid sheet, or any other light-transmissive or opaque thin sheet member. The force sensors 2 are arranged around the substrate 11 of the body 1 and electrically connected to a control unit of an internal circuit board of an electronic device (not shown) for measuring the variation of force applied by an external object touching the surface of the substrate 11 and converting it into a corresponding electronic signal so that the control unit can convert this electronic signal into a corresponding digital signal for analysis to determine the coordinates of a touch point 3 touched, the amount of the applied force, the force change rate and the moving direction of the applied force.

The force sensors 2 can be a multilayer polymer thin film carrying a FSR (force-sensitive resistor) ink layer in a grid pattern. Each grid intersection point of the FSR (force-sensitive resistor) ink layer is a touch point 3 sensitive to force or pressure. However, this arrangement is not a limitation. In actual application, pressure sensor arrays can be used as a substitute. Further, the force sensors can be piezoelectric force sensors, capacitive force sensors, potentiometric force sensors, inductive force sensors, magneto-resistive strain gauges, pneumatic power sensors, or other type force sensors that measure the force or pressure applied and convert it into a digital signal indicative to the coordinates of the touch point and direction of movement of the applied force. As these force/pressure sensing techniques are of the known art and not within the scope of the present invention, no further detailed description in this regard will be necessary.

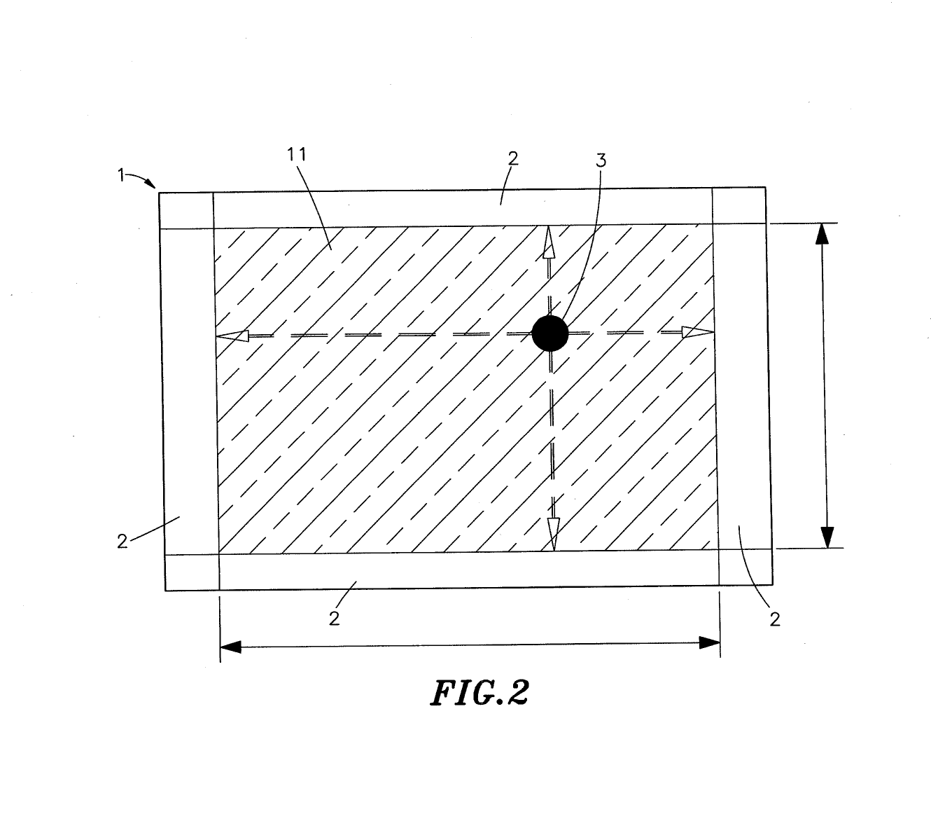

The touch module in accordance with the present invention is practical for use in a smart phone, tablet PC, PDA, game console, interactive multimedia tours guide system, query system or any other electronic device. During application, the body 1 and force sensors 2 of the touch module are mounted inside the electronic device (not shown) and electrically connected to the control unit at the internal mainboard of the electronic device. When an external object (for example a human finger, capacitive stylus or any other conductor, or plastic rod, pencil, eraser, credit card or any other nonconductor) touches the active area of the surface of the substrate 11, the force sensors 2 measure the amount and variation of the force applied to the touch point 3 at the substrate 11 by the external object and provide a corresponding signal to the control unit of the electronic device that converts the received signal into a corresponding digital signal and analyzes the digital signal, subject to the rule that the amount of applied force is inversely proportional to the distance between the touched point and each force sensor or the rule of torque balance relationship, to determine the coordinate position of the touch point 3 touched. As illustrated in FIG. 2, the relationship between the variation of the applied force (for example, Px+, Px−) measured by the force sensors 2 and the length (for example, Lx+, Lx−) of the horizontal axis (X-axis) is:

Px−/Lx+=Px+/Lx−;

Lx−/Lx+=Px+/Px−;

Lx−*Px−=Lx+*Px+; or torque balance relationship (Lx−* Px−)−(Lx+*Px+)=0, and the relationship relative to the vertical axis (Y-axis) is:

Py−/Ly+=Py+/Ly−;

Ly−/Ly+=Py+/Py−;

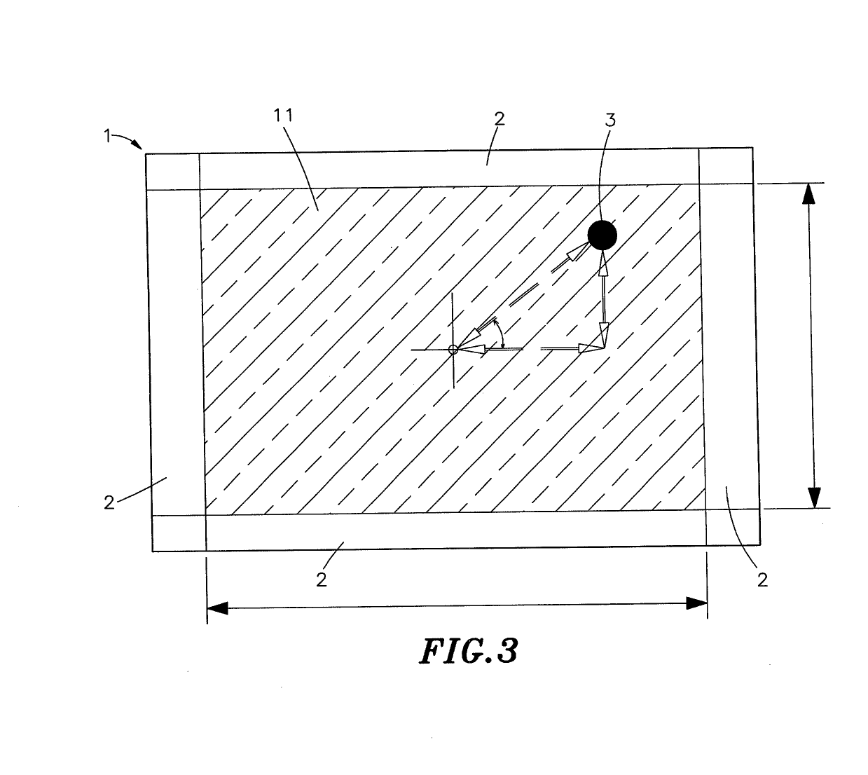

Ly−*Py−=Ly+*Py+; or torque balance relationship (Ly−* Py−)−(Ly+*Py+)=0, and thus, subject to the built-in computing functions, the control unit can determine the planar (two-dimensional) coordinates of the touch point 3. Or, as shown in FIG. 3, the relationship between the variation of the applied force (for example, Px+, Px−, Py+, Py−) measured by the force sensors 2 and the distance between the length (for example, X,Y) and the origin of the Cartesian coordinates center is:

$$X = \frac{Lx}{2} - \frac{Lx}{1 + \frac{Px +}{Px -}} , Y = \frac{Ly}{2} - \frac{Ly}{1 + \frac{Py +}{Py -}} ,$$

and the polar coordinates are (r, θ).

$$When Px + > Px - , \\ r = \sqrt{{[ \frac{Lx}{2} - \frac{Lx}{1 + \frac{Px +}{Px -}} ]}^{2} + {[ \frac{Ly}{2} - \frac{Ly}{1 + \frac{Px +}{Py -}} ]}^{2}} , \\ θ = {tan}^{- 1} \frac{( \frac{Ly}{2} - \frac{Ly}{1 + \frac{Py +}{Py -}} )}{( \frac{Lx}{2} - \frac{Lx}{1 + \frac{Px +}{Px -}} )} ;$$

$$when Px + < Px - , \\ r = \sqrt{{[ \frac{Lx}{2} - \frac{Lx}{1 + \frac{Px +}{Px -}} ]}^{2} + {[ \frac{Ly}{2} - \frac{Ly}{1 + \frac{Py +}{Py -}} ]}^{2}} , \\ θ = π + {tan}^{- 1} \frac{( \frac{Ly}{2} - \frac{Ly}{1 + \frac{Py +}{Py -}} )}{( \frac{Lx}{2} - \frac{Lx}{1 + \frac{Px +}{Px -}} )} ;$$

$$when Px += Px - and Py + > Py - , \\ r = \frac{Ly}{2} - \frac{Ly}{1 + \frac{Py +}{Py -}} , θ = \frac{π}{2} = 90 ° , \\ when Px += Px - and Py + < Py - , \\ r = \frac{Ly}{1 + \frac{Py +}{Py -}} - \frac{Ly}{2} , θ = \frac{3 π}{2} = 270 ° .$$

Thus, it can be further converted to a different input mode (such as the operation of key mode, scroll mode, drag mode or cursor control mode), and the coordinate position of the touch point 3 is displayed on the display screen of the electronic device. Thus, the first operation mode is done.

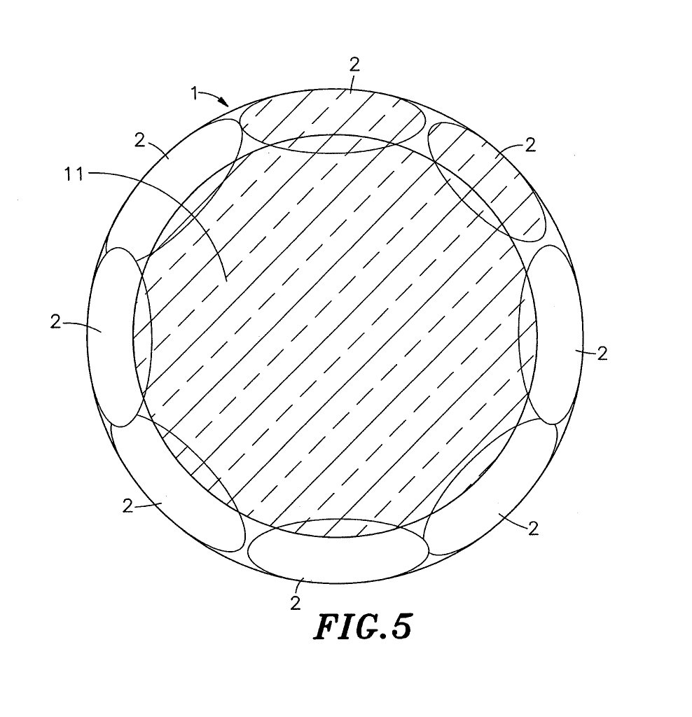

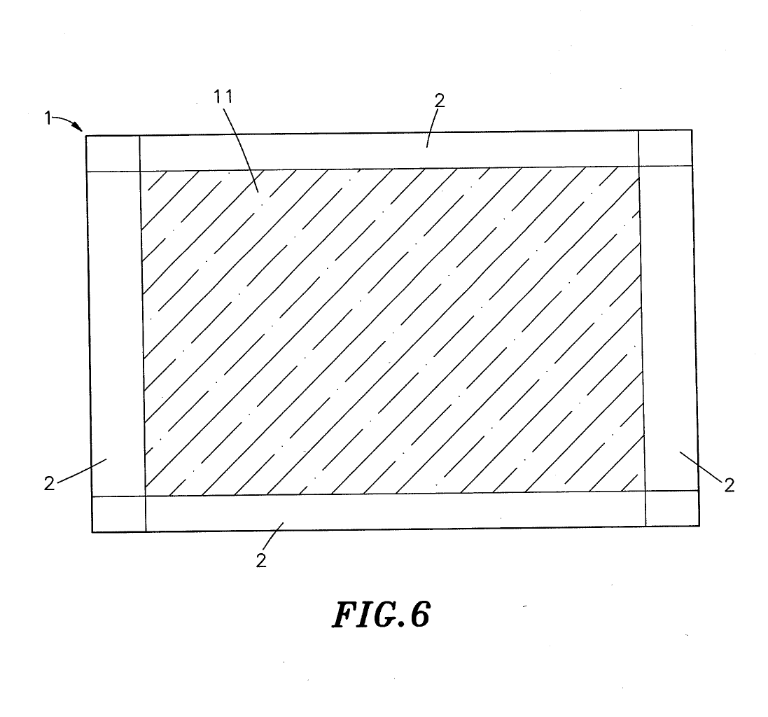

Referring to FIGS. 5 and 6, when an external object applies a force to a predetermined coordinate point A in the active area of the substrate 11 of the body 1, the applied force (for example, APx+, APx−, APy+, APy−) is divided by the position value (for example, ALx−, ALx+, ALy−, ALy+), obtaining the proportional relationship:

APx+/ALx−;

APx−/ALx+;

APy+/ALy−; or

APy−/ALy+,

Therefore, subject to the computing function built in the control unit, the deviation value between the reference value, i.e., the actual value of the position of the coordinate point A stored in the database and the value measured, is obtained and used for correction. Thus, the deviation value relative to the position of the touch point 3 been touched can be corrected subject to different application purposes and status of use.

In one example of the present invention, the substrate 11 of the body 1 is a rectangular substrate, and multiple force sensors 2 are arranged around the four sides of the substrate 11 (see FIG. 1). However, this arrangement is not a limitation. In the example shown in FIG. 5, the substrate 11 is a circular shape (see FIG. 5) with 8 force sensors 2 arranged around the periphery. The substrate 11 can also be configured to provide a polygonal shape, or any other shape. The more the number of the force sensors 2 is, the higher the detection precision will be. Further, the substrate 11 of the body 1 can be a touchpad or touchscreen (see FIG. 6) that can be a resistive type, capacitive type, electromagnetic type, surface acoustic wave type or optical type (infrared) touchpad or touchscreen.

Preferably, the length Lx of the horizontal axis (X-axis) and length Ly of the vertical axis (Y-axis) of the substrate 11 of the body 1 are 300 mm and 200 mm respectively. If an external object touches the active area of the substrate 11, the amount and variation of force measured by the force sensors 2 is Px+=0.6, Px−=0.3, Py+=0.8, Py−=0.2, thus, subject to Lx=Lx++Lx−=300 mm and Lx−/Lx+=Px+/Px−=0.6/0.3=2, Lx+=100 mm, Lx−=200, i.e., the distance between the touch point 3 and the force sensor Px+ is 100 mm and the distance between the touch point 3 and the force sensor Px− is 200 mm. Thereafter, subject to Ly−Ly++Ly−=200 mm and Ly−/Ly+=Py+/Py−=0.8/0.2=4, it can be obtained that Ly+=40 mm, Ly−=160 mm, i.e., the distance between the touch point 3 and the force sensor Py+ is 40 mm and the distance between the touch point 3 and the force sensor Py− is 160 mm. Or, from

$$X = \frac{Lx}{2} - \frac{Lx}{1 + \frac{Px +}{Px -}} = 50 , Y = \frac{Ly}{2} - \frac{Ly}{1 + \frac{Py +}{Py -}} = 60 ,$$

it is known that the Cartesian coordinates of the touched touch point 3 are (50, 60). Because Px+>Px−, thus the polar coordinates (r, θ) are

$$r = \sqrt{{[ \frac{Lx}{2} - \frac{Lx}{1 + \frac{Px +}{Px -}} ]}^{2} + {[ \frac{Ly}{2} - \frac{Ly}{1 + \frac{Py +}{Py -}} ]}^{2}} = 78.1 ,$$

$$θ = {tan}^{- 1} \frac{( \frac{Ly}{2} - \frac{Ly}{1 + \frac{Py +}{Py -}} )}{( \frac{Lx}{2} - \frac{Lx}{1 + \frac{Px +}{Px -}} )} = 50.2 ° .$$

Hence, the planar (two-dimensional) coordinates of the touch point 3 touched by the external conductor or nonconductor is measured, avoiding positional deviation or touch error when a human body touches a small area point target (for example, clicking a flexible membrane keyboard to input a telephone number or Chinese/English words), preventing touchpad or touchscreen failure due to interference of surrounding electric induction or magnetic induction, and improving the touch point sensing accuracy.

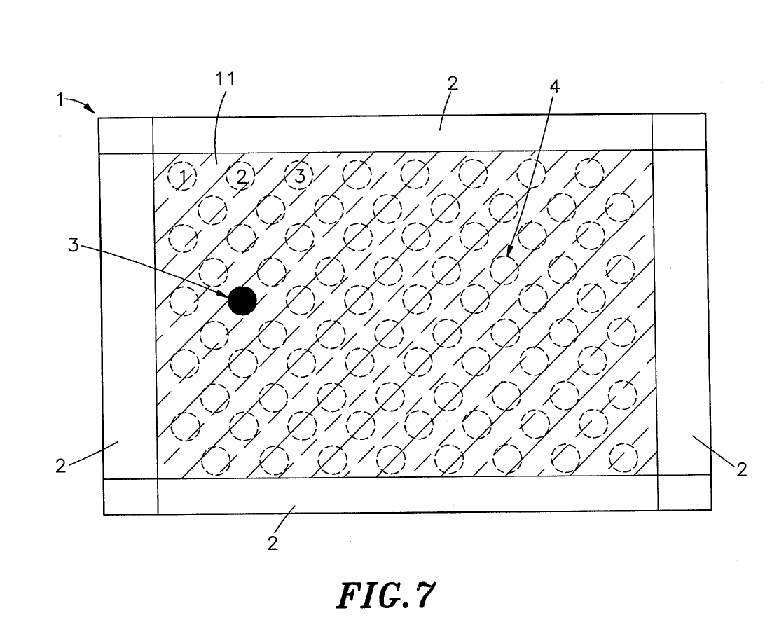

Referring to FIG. 7 and FIG. 1 again, the active area of the substrate 11 of the body 1 is configured, based on a pre-simulation process, to provide multiple coordinate points 4 in the form of a grid pattern, and a database is established by the control unit subject to the proportional relationship among the variation of force measured by every of the force sensors 2 upon the touch of an external object at every coordinate point 4, as shown in Table 1, wherein t, u, v, w are the tolerance coefficient or correction parameter of Px+, Px−, Py+, Py− respectively. When an object touches any predetermined coordinate point 4, the control unit matches the proportional relationship among the values detected by the force sensors 2 around the substrate 11 with the database to determine the coordinates of the touched point, and interpolation function or extrapolation function can be employed to increase the resolution of the coordinate position, more accurately determining the planar (two-dimensional) coordinates of the touched point. This is a second operation mode of the present invention.

TABLE 1
Force sensor coordinate position proportional
relationship table

| | Px+ | | | | |
|---|---|---|---|---|---|
| | force | Px− | Py+ | Py− | |
| No | sensor | force sensor | force sensor | force sensor | coordinates |
| 1 | 2 ± t | 8 ± u | 5 ± v | 1 ± w | (−10, 5) |
| 2 | 4 ± t | 6 ± u | 5 ± v | 1 ± w | (−8, 5) |
| 3 | 6 ± t | 4 ± u | 5 ± v | 1 ± w | (−6, 5) |
| . | . | . | . | . | . |
| . | . | . | . | . | . |
| . | . | . | . | . | . |

Referring to FIGS. 2, 3, 4 and 7 again, when an external object touches a touch point 3 at the substrate 11, the force sensors 3 around the substrate 11 measures the amount and variation of the applied force and provide a corresponding electronic signal for analysis by the control unit to determine the coordinates of this touch point 3 touched and the amount, variation and direction of movement of the applied force. Subject to different purposes, application conditions and types of touch objects, the touch module can be switched between the first operation mode and the second operation mode. Further, the substrate 11 can be a planar tempered glass, rigid sheet, or any other light-transmissive or opaque thin sheet member. The invention effectively eliminates the drawbacks of low light transmissivity and low rigidity of conventional resistive type touchpads and touchscreens, and the drawbacks of nonconductor inapplicability, positional deviation, high error rate, high risk of touchpad or touchscreen failure of conventional induction type, capacitive type and electromagnetic type touchpads and touchscreens.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A touch module, comprising:
a body comprising a substrate defining an active area and a plurality of touch points in said active area;
a plurality of force sensors arranged around said substrate for measuring the variation of force at each said touch point when an external object touching said active area of said substrate and converting the variation of force at each said touch point into a corresponding electronic signal; and
a control unit electrically connected with said force sensors for receiving the electronic signal provided by each said force sensor and converting the electronic signal into a corresponding digital signal for determination of the two-dimensional coordinates of the touch point touched subject to the rule that the amount of applied force is inversely proportional to the distance between the touched point and each said force sensor or the rule of torque balance relationship.

2. The touch module as claimed in claim 1, wherein said substrate is selectively prepared from the group of tempered glass, rigid sheet materials, light-transmissive thin sheet materials and opaque thin sheet materials.

3. The touch module as claimed in claim 1, wherein said substrate is selected from the group of resistive type, capacitive type, electromagnetic type, surface acoustic wave type and optical type (infrared) touchpads and touchscreens.

4. The touch module as claimed in claim 1, wherein each said force sensor is selectively made in the form of a multilayer polymer thin film carrying a FSR (force-sensitive resistor) ink layer in a grid pattern, or the form of a pressure sensor array.

5. The touch module as claimed in claim 1, wherein said force sensors are selected from the group of piezoelectric force sensors, capacitive force sensors, potentiometric force sensors, inductive force sensors, magneto-resistive strain gauges and pneumatic power sensors.

6. The touch module as claimed in claim 1, wherein when an external object touches one predetermined coordinate point in said active area of said substrate of said body, the applied force is divided by the position value to provide a proportional relationship, so that said control unit measures a deviation value between the actual value of the position of the coordinate point stored in the database and the value measured for correction.

7. A touch module, comprising a body, said body comprising a substrate, said substrate defining an active area, a plurality of touch points arranged in a grid pattern in said active area, and a control unit electrically connected with said force sensors, said control unit being adapted to establish a database subject to the proportional relationship obtained by using an object to touch each said coordinate point in said active area of said substrate and comparing the amount and variation of the applied force measured by each said force sensor so that when an external object touches one said coordinate point in said sensitive area of said substrate, said control unit determines the two-dimensional coordinates of the touched point by matching the proportional relationship obtained from the values measured by said force sensors with said database.

8. The touch module as claimed in claim 7, wherein aid substrate is selectively prepared from the group of tempered glass, rigid sheet materials, light-transmissive thin sheet materials and opaque thin sheet materials.

9. The touch module as claimed in claim 7, wherein said substrate is selected from the group of resistive type, capacitive type, electromagnetic type, surface acoustic wave type and optical type (infrared) touchpads and touchscreens.

10. The touch module as claimed in claim 7, wherein each said force sensor is selectively made in the form of a multilayer polymer thin film carrying a FSR (force-sensitive resistor) ink layer in a grid pattern, or the form of a pressure sensor array.

11. The touch module as claimed in claim 7, wherein said force sensors are selected from the group of piezoelectric force sensors, capacitive force sensors, potentiometric force sensors, inductive force sensors, magneto-resistive strain gauges and pneumatic power sensors.

12. The touch module as claimed in claim 7, wherein when an external object touches one predetermined coordinate point in said active area of said substrate of said body, the applied force is divided by the position value to provide a proportional relationship, so that said control unit measures a deviation value between the actual value of the position of the coordinate point stored in the database and the value measured for correction.

13. The touch module as claimed in claim 7, wherein said control unit matches the proportional relationship among the values detected by said force sensors with said database to determine the two-dimensional coordinates of the touched point using the interpolation function or extrapolation function.
